(19) United States
(12) Patent Application Publication
(10) Pub. No.: US 2019/0114711 A1
(43) Pub. Date: Apr. 18, 2019

(54) FINANCIAL ANALYSIS SYSTEM AND METHOD FOR UNSTRUCTURED TEXT DATA

(71) Applicant: YUAN ZE UNIVERSITY, Taoyuan City (TW)

(72) Inventors: LIANG-CHIH YU, Taoyuan City (TW); LI-CHUAN LIAO, Keelung City (TW)

(21) Appl. No.: 15/822,140

(22) Filed: Nov. 25, 2017

(30) Foreign Application Priority Data
Oct. 13, 2017 (TW) 106135125

(51) Int. Cl. G06Q 40/06; G06F 17/30

(52) U.S. Cl. CPC G06Q 40/06; G06F 17/30684

(57) ABSTRACT

Disclosed are a financial analysis system and a financial analysis method for unstructured text data. In the financial analysis system, a user interface is configured to input a keyword and display an analysis result, a server is configured to manage at least one database, and a memory is configured to store an analysis program. In addition, a processor is configured to execute the analysis program for implementing the financial analysis method. The financial analysis method includes: according to the keyword, searching for a plurality of news related to the keyword within a predetermined time segment; and according to the news, executing a vocabulary analysis at every time point within the predetermined time segment to calculate an overall optimistic factor and an overall encouraging factor as the analysis result.

### BACKGROUND OF THE INVENTION

### 1. Field of the Invention

The present disclosure relates to a financial analysis system and a financial analysis method for unstructured text data; in particular, to a financial analysis system and a financial analysis method for unstructured text data that can convert unstructured text data to structured data.

### 2. Description of Related Art

Currently, the analysis of the stock market relies only on structured data, such as the stock volume or the price variation within each time interval. The analysis results generated by this kind of analysis can be represented by structured indexes (i.e., quantized values). Converting structured data into structured indexes is a general way to perform an analysis of the stock market nowadays. These structured indexes may have different definitions but can only be represented by quantized values, such as 0-9.

However, what actually affects the future stock volume and the future price variation is not the current or the historical stock volume and price variation, but the daily news in different industries. Even so, it is difficult to analyze stock market according to the daily news in different industries, because daily news in different industries is directed unstructured text data and it is hard to convert the unstructured text data into structured indexes.

### SUMMARY OF THE INVENTION

In order to effectively predict the future stock volume or the future stock index according to daily news in each industry, the present disclosure provides a financial analysis system and a financial analysis method for unstructured text data, which is capable of converting unstructured text data into structured data.

The financial analysis system for unstructured text data provided by the present disclosure includes a user interface, a server, a memory and a processor. The user interface is configured to input a keyword and display an analysis result. The server is configured to operate at least one database. The memory is configured to store an analysis program. The processor is connected to the user interface, the server and the memory. The processor is configured to execute the analysis program for: searching for a plurality of news related to the keyword within a predetermined time segment through the server; and executing a vocabulary analysis at every time point within the predetermined time segment according to the news to calculate an overall optimistic factor and an overall encouraging factor as the analysis result. It should be noted that the overall optimistic factor is defined as what the emotion the public may have when hearing the news, and the overall encouraging factor is defined as how the public expect for the occurrence of the news.

In one embodiment of the financial analysis system for unstructured text data provided by the present disclosure, after the processor searches for the news related to the keyword within the predetermined time segment through the server, the processor executes the analysis program further for: capturing some of the news related to the keyword through the server according to a selected time segment; and calculating and generating a word cloud as the analysis result according to the captured news.

The financial analysis method for unstructured text data provided by the present disclosure is adapted to a financial analysis system for unstructured text data. The financial analysis system for unstructured text data includes a user interface, a server, memory and a processor. The user interface is configured to input a keyword and display an analysis result. The server is configured to operate a database. The memory is configured to store an analysis program. The processor is connected to the user interface, the server and the memory, and is configured to execute the analysis program to implement the financial analysis method for unstructured text data. The financial analysis method includes: searching for a plurality of news related to the keyword within a predetermined time segment through the server; and executing a vocabulary analysis at every time point within the predetermined time segment according to the news to calculate an overall optimistic factor and an overall encouraging factor as the analysis result. It should be noted that, the overall optimistic factor is defined as what the emotion the public may have when hearing the news, and the overall encouraging factor is defined as how the public expect for the occurrence of the news.

By using the financial analysis system and method for unstructured text data provided by the present disclosure, unstructured text data, such as daily news in different industries, can be converted into many kinds of analysis results which are represented as structured data. In this manner, the trend of the stock market, such as stock volume, stock index . . . etc., can be more effectively predicted. Comparing with the conventional financial analysis system and method that predict the trend of the stock market according to the current or the historical stock volume and stock index, the analysis results generated by the present disclosure are much more reliable.

For further understanding of the present disclosure, reference is made to the following detailed description illustrating the embodiments of the present disclosure. The description is only for illustrating the present disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a financial analysis system for unstructured text data according to one embodiment of the present disclosure;

FIG. 2 shows a flowchart of a financial analysis system for unstructured text data according to one embodiment of the present disclosure;

FIG. 3 shows a flowchart of a financial analysis system for unstructured text data according to another embodiment of the present disclosure;

FIG. 4 shows a schematic diagram of an analysis result generated by the financial analysis system for unstructured text data according to one embodiment of the present disclosure;

FIG. 5 shows a schematic diagram of an analysis result generated by the financial analysis system for unstructured text data according to another embodiment of the present disclosure; and

FIG. 6 shows a schematic diagram of an analysis result generated by the financial analysis system for unstructured text data according to still another embodiment of the present disclosure.

### DETAILED DESCRIPTION OF EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings. In these drawings, like references indicate similar elements.

To more effectively predict the future trend of the stock market, the financial analysis system and the financial analysis method for unstructured text data provided by the present disclosure convert unstructured text data, such as daily news in different industries, into structured data and accordingly generate many kinds of analysis results. These analysis results are more worth to be used for predicting the future trend of the stock market because the analysis results are generated based on the daily news in different industries, which actually happens in each industry every day. There are several embodiments provided in the following description for illustrating the financial analysis system and the financial analysis method for unstructured text data provided by the present disclosure.

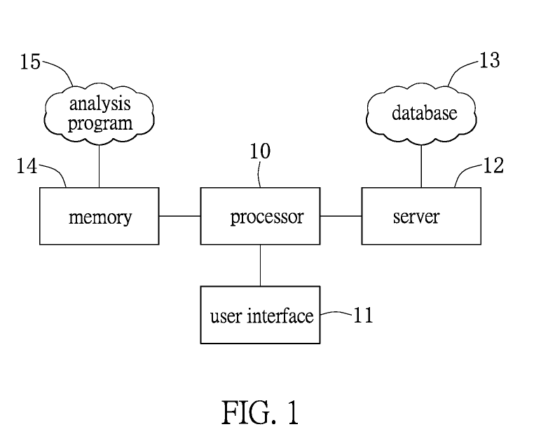

The system structure of the financial analysis system for unstructured text data provided by the present disclosure can be referred to FIG. 1. FIG. 1 shows a block diagram of a financial analysis system for unstructured text data according to one embodiment of the present disclosure.

As shown in FIG. 1, the financial analysis system for unstructured text data provided by this embodiment includes a processor 10, a user interface 11, a server 12 and a memory 14. The user interface 11 is configured to input a keyword and to display analysis results. The server 12 is configured to operate at least one database. The memory 14 is configured to store an analysis program 15. The processor 10 is connected to the user interface 11, the server 12 and the memory 14. In this embodiment, the processor 10, the user interface 11 and the memory 14 can be implemented by an electronic device, such as a personal computer or a smart phone, and the server 12 can be implemented by a server device capable of communicating with electronic devices through a network.

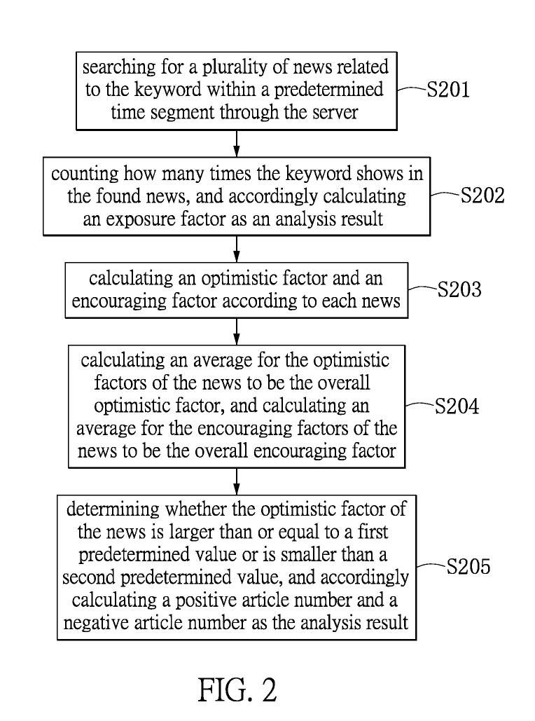

Referring to FIG. 2, a flow chart of a financial analysis system for unstructured text data according to one embodiment of the present disclosure is shown.

The financial analysis method for unstructured text data provided in this embodiment, is implemented by the processor 10 executing an analysis program 15 stored in the memory 14 as shown in the financial analysis system for unstructured text data in FIG. 1. Thus, referring collectively to FIG. 1 and FIG. 2 helps to better comprehend the financial analysis method for unstructured text data provided in this embodiment. As shown in FIG. 2, the financial analysis method for unstructured text data provided in this embodiment includes the following steps: searching for a plurality of news in the database 13 related to the keyword within a predetermined time segment through the server 12 (step S201); counting how many times the keyword shows up in the news found, and accordingly calculating an exposure factor as an analysis result (step S202); calculating an optimistic factor and an encouraging factor for each news (step S203); calculating an average for the optimistic factors of the news to be the overall optimistic factor, and calculating an average for the encouraging factors of the news to be the overall encouraging factor (step S204); and determining whether the optimistic factor of the news is larger than or equal to a first predetermined value or is smaller than a second predetermined value, and accordingly calculating a positive article number and a negative article number as the analysis result (step S205).

Details with respect to each of the above steps are illustrated in the following description.

In step S201, when a user inputs a keyword through the user interface 11, the processor 10, within a predetermined time segment, searches for a plurality of news in the database 13 related to the keyword through the server 12. In this embodiment, the keyword inputted by the user can be a stock symbol or a company name. If the keyword inputted by the user is a stock symbol, the processor 10, through the server 12, searches from the database 13 for the news in which the company name corresponding to the stock symbol shows. If the keyword inputted by the user is a company name, the processor 10 searches for the news in which the company name shows from the database 13 through the server 12.

It should be noted that, the term “unstructured text data” is defined as the text data not in a specific data form or a database form, such as articles, comments or news obtained from the Internet, the social media or the like. In addition, as described, the server 12 operates at least one database 13, and it should be noted that the data source of the database 13 can be daily news released or published by every news website, and it is not limited thereto.

For example, if the user inputs a keyword “2317”, which is a stock symbol, the processor 10 searches for the news in which the company name (e.g. company A) corresponding to the stock symbol “2107” can be found from the database 13 through the server 12. If the user inputs a keyword “company A”, which is a company name, the processor 10 searches for the news in which the company name “company A” can be found from the database 13 through the server 12.

The user can input a specific time segment by using the user interface 11. Then, the processor 10 can search for the news related to the keyword within the specific time segment from the database 13 through the server 12.

Without inputting any specific time segment, the processor 10 will search for a plurality of news related to the keyword within a predetermined time segment from the database 13 through the server 12. For example, the predetermined time segment can be six months back from the day the search is requested. If the user inputs a specific time segment (e.g. 2017/07/23˜2017/08/23) through the user interface, the processor 10 will search for the news related to the keyword within the specific time segment (i.e., 2017/07/23˜2017/08/23) from the database 13 through the server 12.

In step S202, when the keyword “company A” is inputted, the processor 10 will counts how many times that the “company A” shows in the news found and, accordingly calculate an exposure factor as the analysis result. Herein, the exposure factor is defined as the frequency that the term “company A” shows in the news found within a time segment, so it can also be called “word frequency”. A high exposure factor shows that the term “company A” has a high word frequency, which means that the term “company A” frequently shows in the found news. On the other hand, a low exposure factor shows that the term “company A” has a low word frequency, which means that the term “company A” less company name shows in the found news.

After that, in step S203, if the user inputs the “company A” as a keyword, the processor 10 executes a vocabulary analysis for the text contents of each found news to calculate an optimistic factor and an encouraging factor. It should be noted that, the optimistic factor is defined as what emotion (e.g. happiness or upset) the public may have when hearing the news, and the encouraging factor is defined as how much the public expect for the occurrence of the news (e.g. excitation or not dullness).

The analysis program 15 executed by the processor 10 includes a preset dictionary. In this preset dictionary, a plurality of words relevant to emotions, and an emotion point and an expectation point corresponding to each word relevant to emotions are recorded. The emotion point and the expectation point are both real numbers from 1 to 9. If a word has a high emotion point, the public is generally optimistic when reading this word, but if a word has a low emotion point, the public is generally pessimistic when reading this word. In addition, if a word has a high expectation point, the public is generally excited when reading this word, but if a word has a low expectation point, the public shows less care when reading this word.

In this embodiment, for each of the news, the processor 10 finds out all the words relevant to emotions in the news according to the preset dictionary, and then calculates the emotion point and the expectation point for all the words relevant to emotions in the news. Finally, the processor 10 calculates an average of the emotion points and an average of the expectation points of all the words relevant to emotions in the news, to obtain the optimistic factor and the encouraging factor of the news.

For example, the processor 10 finds the words relevant to emotions in the news, e.g. “grow” and “overbought”. According to the preset dictionary, the emotion point and the expectation point of the word “grow” respectively are 4.8 and 6.0, and the emotion point and the expectation point of the word “overbought” respectively are 6.0 and 6.0. In this example, the processor 10 can calculates the optimistic factor and the encouraging factor of the news, which are respectively 5.4 (i.e., (5.4+6.0)/2) and 6.0 (i.e., (6.0+6.0)/2).

In step S204, for example, the processor 10 calculates the optimistic factors/the encouraging factors for all news released at a certain date (e.g., 2017/8/20) within the predetermined time segment (e.g., 2017/6/23˜2017/8/23), which are respectively 5.4/6.0, 6.1/6.8/ and 5.2/7.0. In this example, the processor 10 calculates an average of the optimistic factors of these news and calculates an average of the encouraging factors of these news to obtain an overall optimistic factor, which is 5.6 (i.e., (5.4+6.1+5.2)/3), and an overall encouraging factor, which is 6.6 (i.e., (6.0+6.8+7.0)/3).

Finally, in step S205, the processor 10 determines whether the optimistic factor of each of the news found is larger than or equal to a first predetermined value or is smaller than a second predetermined value to calculate a positive article number and a negative article number at each time point (e.g., each day) within the predetermined time segment, and treats the positive article numbers and the negative article numbers as the analysis results. When calculating the positive article number and the negative article number, if the optimistic factor of a news is larger than or equal to the first predetermined value, the processor 10 adds 1 to the positive article number; on the other hand, if the optimistic factor of a news is smaller than the second predetermined value, the processor 10 adds 1 to the negative article number.

Assumed that the first predetermined value is 5.5, the second predetermined value is 4.5, and the processor 10 calculates the optimistic factors of all news (e.g. 10 news) on a certain date (e.g. 2017/8/1) within the predetermined time segment (e.g., 2017/6/23˜2017/8/23), which are 5.1. 7.2. 5.0. 4.6. 3.3. 6.8. 6.7. 4.1. 6.5 and 7.4. In this case, the processor 10 calculates the positive article number and the negative article number on 2017/8/1 to be 5 and 2. It is worth mentioning that, the news with the optimistic factors of 5.1, 5.0 and 4.6 are determined as neutral articles, and these neutral articles are excluded when calculating the positive article number and the negative article number because it is hard to evaluate how the public react when reading these news.

In addition, assuming that the first predetermined value is 5.0, the second predetermined value is 4.5, and the processor 10 calculates the optimistic factors of all news (e.g. 10 news) at a certain date (e.g. 2017/8/1) within the predetermined time segment (e.g., 2017/6/23˜2017/8/23), which are 5.1. 7.2. 5.0. 4.6. 3.3. 6.8. 6.7. 4.1. 6.5 and 7.4. In this case, the positive article number and the negative article number on 2017/8/1 obtained by the processor 10 will be 7 and 3. In this embodiment, it is indicated that the first predetermined value and the second predetermined value can be set through the analysis program by a system manager, and the first predetermined value and the second predetermined value can be, but not limited to, equal or unequal to each other.

By using the above-described financial analysis system and method for unstructured text data, the daily news in different industries, which are unstructured text data, can be converted into analysis results, such as the exposure factor, the optimistic factor, the encouraging factor, the positive article number and the negative article number, which are more convincing. These analysis results are obtained by analyzing the news in different industries according to the time when the news are released, so that it is convenient and useful for the user to predict the trend of the stock market in the future based on these analysis results.

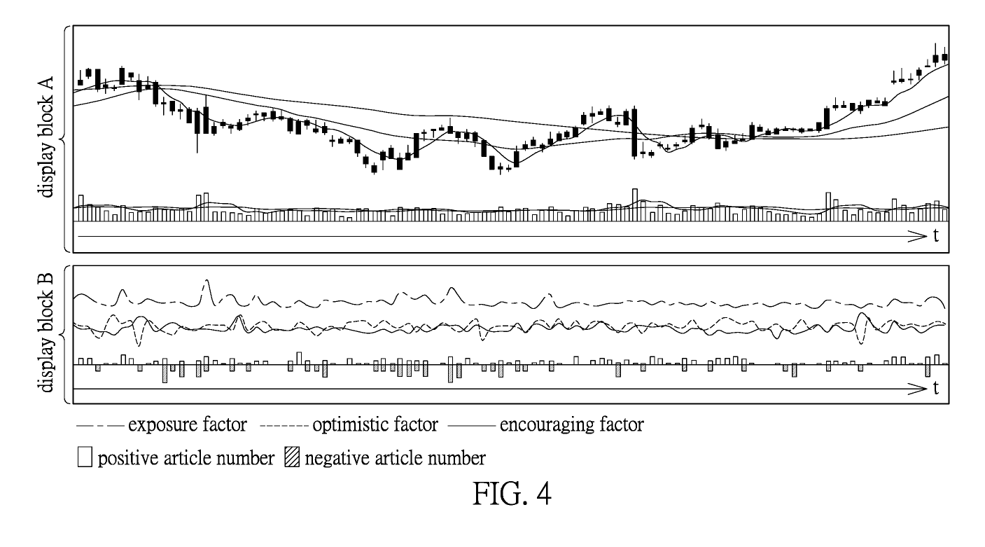

Referring to FIG. 4, a schematic diagram of an analysis result generated by the financial analysis system for unstructured text data according to one embodiment of the present disclosure is shown.

The analysis results generated after the financial analysis system for unstructured text data provided by this embodiment executes the financial analysis method for unstructured text data shown in FIG. 2 are displayed by the user interface 11. As shown in FIG. 4, a display image of the user interface 11 includes a display block A and a display block B. The display block A shows a plurality of indexes for certain company at each time points on the time axis t, and these indexes can usually be obtained by a general financial analysis, such as the stock volume, the stock price, the k-line and the like. The display block B shows the above-described exposure factor, optimistic factor, encouraging factor, positive article number and negative article number for certain company at each time points on the time axis t.

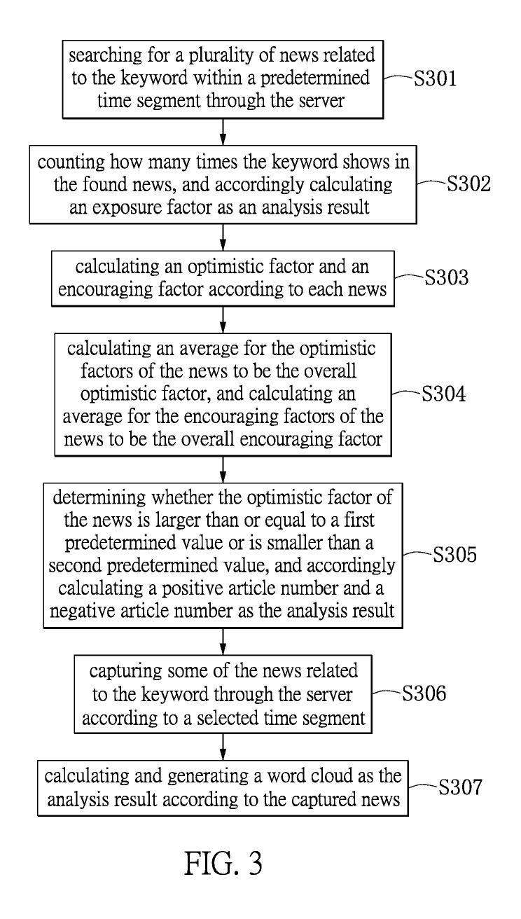

Reference is next made to FIG. 3, a flow chart of a financial analysis system for unstructured text data according to another embodiment of the present disclosure is shown.

The financial analysis method for unstructured text data provided by this embodiment is also implemented by the processor 10 executing an analysis program 15 stored in the memory 14 as shown in the financial analysis system for unstructured text data in FIG. 1. Thus, referring collective to FIG. 1 and FIG. 3 helps to better comprehend the financial analysis method for unstructured text data provided in this embodiment. As shown in FIG. 3, the financial analysis method for unstructured text data provided by this embodiment includes the following steps: searching for a plurality of news in the database 13 related to the keyword within a predetermined time segment through the server 12 (step S301); counting how many times the keyword shows up in the news found, and accordingly calculating an exposure factor as an analysis result (step S302); calculating an optimistic factor and an encouraging factor for each news (step S303); calculating an average for the optimistic factors of the news to be the overall optimistic factor, and calculating an average for the encouraging factors of the news to be the overall encouraging factor (step S304); determining whether the optimistic factor of the news is larger than or equal to a first predetermined value or is smaller than a second predetermined value, and accordingly calculating a positive article number and a negative article number as the analysis result (step S305); capturing some of the news related to the keyword through the server 12 according to a selected time segment (step S306); and calculating and generating a word cloud as the analysis result according to the captured news (step S307).

Details with respect to each of the above steps are illustrated in the following description. However, it is worth mentioning that, the steps S301˜S305 in the financial analysis method for unstructured text data provided by this embodiment are similar to the steps S201˜S205 in the financial analysis method for unstructured text data shown in FIG. 2, and thus details about the steps S301˜S305 can be referred to the above description relevant to the details about the steps S201˜S205. Only differences between the financial analysis method for unstructured text data provided by this embodiment and the financial analysis method for unstructured text data shown in FIG. 2 will be illustrated in the following description.

For example, when the user inputs a keyword “2317”, which is a stock symbol, the processor 10 searches for the news in which the company name (e.g. company A) corresponding to the stock symbol “2317” can be found from the database 13 through the server 12. Then, according to the found news, the processor 10 executes the steps S302˜S305 to calculate the exposure factor, the optimistic factor, the encouraging factor, the positive article number and the negative article number for company A at each time point on the time axis.

Then, in step S306, according to a selected time segment, the processor 10 captures some of the news found related to the keyword through the server 12. It is noted that, the selected time segment is defined as a selected time segment within the predetermined time segment or a selected time segment within a specific time segment set by the user.

After executing steps S301˜S305, the exposure factor, the optimistic factor, the encouraging factor, the positive article number and the negative article number of company A are shown in the display block B. Also, a plurality of general indexes for company A at each time point on the time axis, such as the stock volume, the stock price, the k-line and the like, are shown in the display block A. In this case, for example, the user can click any k-line shown in the display block A to determine the above described selected time segment. The chosen k-line corresponds to a time point on the time axis (e.g., 2017/04/07). If the selected time segment set in the analysis program 15 is defined as a time segment counted 3 days before and after the chosen date, in this example, the selected time segment will be 2017/04/04˜2017/04/10. Thus, in step S306, the processor 10 captures the news released within the 2017/04/04˜2017/04/10 from the news found in step S301.

It should be noted that, in this embodiment and the embodiment shown in FIG. 2, the processor 10 obtains the general indexes for certain company at each time point on the time axis, such as the stock volume, the stock price, the k-line and the like from the database 13 through the server 12. In practice, the data source of the database 13 can be, for example, the trade information released by each stock exchange. It should also be noted that, in addition to the k-lines, the user can also pick up one node of the stock volume or the stock prize shown in the display block A, and the selected time segment is determined based on the time point corresponded to the chosen node.

In step S307, the processor 10 calculates and then generates a word cloud as the analysis result according to the news captured in step S306. To generate a word cloud, for each of the captured news, the processor 10 builds a word range having the keyword as a range center (e.g., 50 words before and after the keywords). Then, the processor 10 captures the words used in the word range, and ranks the words according to how many times they appears in the word range. It should be noted that, in this embodiment, the word range can be preset in the analysis program or can be set by the user through the user interface 11. Assuming that the word “company A” appears in one captured news for three times, the processor 10 takes the first shown “company A” as a range center and chooses 50 words before the range center and 50 words after the range center to build a word range, then takes the second shown “company A” as a range center and chooses 50 words before the range center and 50 words after the range center to build another word range, and takes the third shown “company A” as a range center and chooses 50 words before the range center and 50 words after the range center to build still another word range.

Then, the processor 10 calculates and generates a word cloud according to a predetermined word number. The predetermined word number can be preset in the analysis program 15 or can be set by the user through the user interface 11. Assuming that the predetermined word number is 120, the processor 10 generates a word cloud by using the captured words in all word ranges, which are ranked at top 120. Thus, this word cloud can indicate the news information of company A within the selected time segment corresponding to the chosen k-line.

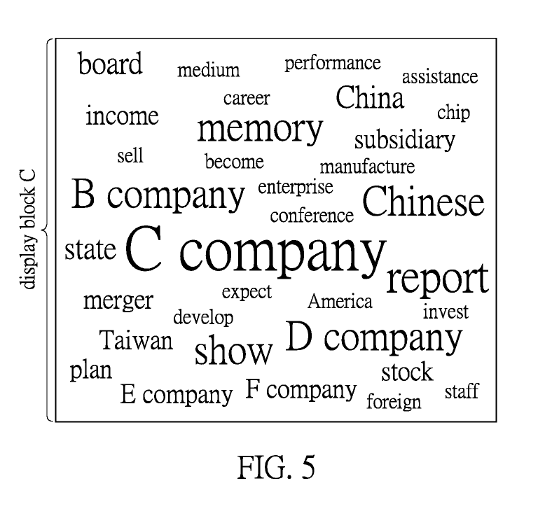

Referring to FIG. 5, a schematic diagram of an analysis result generated by the financial analysis system for unstructured text data according to another embodiment of the present disclosure is shown.

The analysis results generated after the financial analysis system for unstructured text data provided by this embodiment executes the financial analysis method for unstructured text data shown in FIG. 3 are displayed by the user interface 11. In this embodiment, in addition to the display block A and the display block B, the display image of the user interface 11 further has a display block C. The word cloud generated after the processor 10 executes the steps S301, S306 and S307 is displayed in the display block C, as shown by the word cloud in FIG. 5.

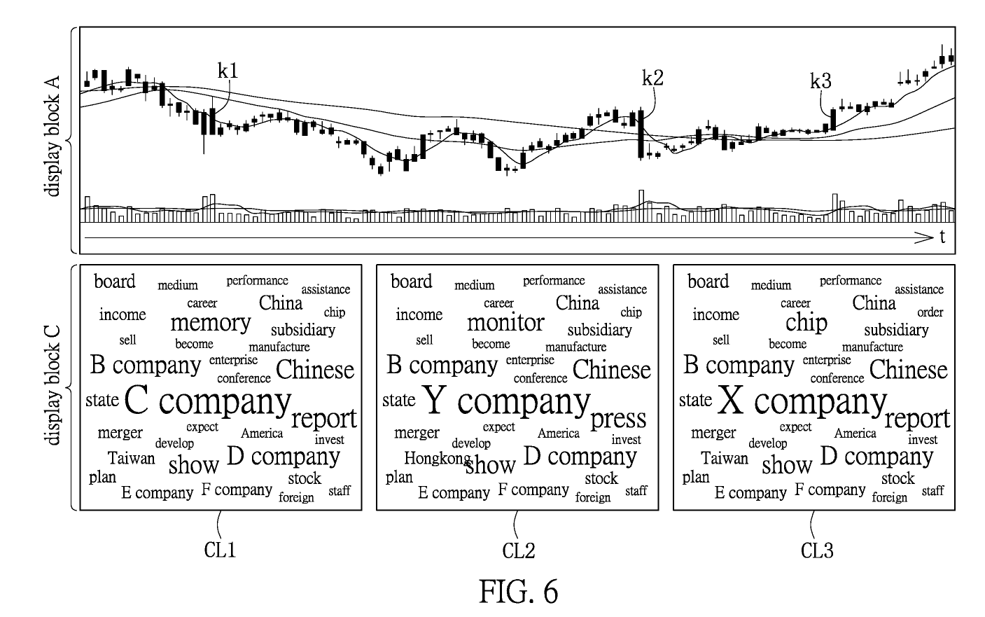

Moreover, referring to FIG. 6, a schematic diagram of an analysis result generated by the financial analysis system for unstructured text data according to still another embodiment of the present disclosure is shown.

In this embodiment, when the user clicks on more than one k-line (e.g., the k-lines k1, k2 and k3), the processor 10 executes the steps S301, S306 and S307 and thus three word clouds CL1, CL2 and CL3 are correspondingly generated. These word clouds CL1, CL2 and CL3 are displayed in the display block C of the user interface 11, which indicate the news information of company A within three selected time segments respectively corresponding to the chosen k-lines k1, k2 and k3. For example, the selected time segments respectively corresponding to the chosen k-lines k1, k2 and k3 are 2016/03/1˜2016/03/04, 2016/03/7˜2016/03/10 and 2016/05/9˜2016/05/12. In this example, the word clouds CL1, CL2 and CL3 indicate the news information of company A within 2016/03/1˜2016/03/04, 2016/03/7˜2016/03/10 and 2016/05/9˜2016/05/12. Accordingly, the analysis results (i.e. the word clouds) in FIG. 6 can be considered as a news information flow indicating a market/industry/stock trend variation with time.

It should be noted that, those skilled in the art should understand other details about how to generate a word cloud, and thus no further illustration is addressed herein. However, it should be noted that, there are differences between the word clouds generated by executing the financial analysis method for unstructured text data provided by the present disclosure and the word clouds often shown in the general news analysis or through the social media. The word clouds frequently shown in the general news analysis or through the social media are generated according to how many times each word shows in an input article. However, the word clouds generated by executing the financial analysis method for unstructured text data provided by the present disclosure are generated according to the news having a determined keyword and how many time each word shows in each word range having the keyword as a center. In addition, in this embodiment, the news having the key word for generating a word cloud are all published or released within a selected time segment. Thus, the word clouds corresponding to different selected time segments can be considered as a news information flow indicating a market/industry/stock trend variation with time

Therefore, the word clouds generated by executing the financial analysis method for unstructured text data provided by the present disclosure are strongly related to the keyword (e.g. a company name) inputted by the user. Based on the word clouds corresponding to different selected time segments, the user can effectively learn the recent operation or predict the future development of a company and thus, the user can come out with reliable investment strategies.

Finally, it is clarified that, the sequence of steps in FIG. 2 and the sequence of steps in FIG. 3 are set for a need to instruct easily, and thus the sequence of the steps is not used as a condition in demonstrating the embodiments of the present disclosure. In other words, in other embodiments of the present disclosure, the sequence of the steps could be changed, some of the steps could be combined or some of steps could be omitted.

To sum up, by using the financial analysis system and method for unstructured text data provided by the present disclosure, unstructured text data, such as daily news in different industries, can be converted into many kinds of analysis results which are represented as structured data. In this manner, the trend of the stock market, such as stock volume, stock index, . . . , etc., can be more effectively predicted.

The financial analysis system for unstructured text data provided by the present disclosure is easy to operate. After inputting a key word, the user only needs to picks up one of indexes (e.g., a node of the stock volume curve, a node of the stock price cure or a k-line) at a time point shown in the display image of the user interface, the financial analysis system for unstructured text data provided by the present disclosure can generate many kinds of analysis results which are structured data, such as the exposure factor, the optimistic factor, the encouraging factor, the positive article number, the negative article number and the word cloud. According to these analysis results, the user can know whether a company's recent development is active or whether the prospect of a company is brightening. Particularly, according to the word clouds, the user can quickly learn the factors related to the recent development of certain company.

Comparing with the conventional financial analysis system and method that predict the trend of the stock market according to the current or the historical stock volume and stock index, the analysis results generated by the present disclosure are much more worthy.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A financial analysis system for unstructured text data, comprising:
a user interface, configured to input a keyword and display an analysis result;
a server, configured to operate at least one database;
a memory, configured to store an analysis program; and
a processor, connected to the user interface, the server and the memory, and configured to execute the analysis program for:
searching for a plurality of news related to the keyword within a predetermined time segment through the server; and
executing a vocabulary analysis at every time point within the predetermined time segment according to the news to calculate an overall optimistic factor and an overall encouraging factor as the analysis result;
wherein the overall optimistic factor is defined as what the emotion the public may have when hearing the news, and the overall encouraging factor is defined as how the public expect for the occurrence of the news.

2. The financial analysis system according to claim 1, wherein the overall optimistic factor is a real number from 1 to 9, and the larger the overall optimistic factor is, the more optimistic the public may be when hearing the news, and the smaller the overall optimistic factor is, the more pessimistic the public may be when hearing the news, and wherein the overall encouraging factor is a real number from 1 to 9, and the larger the overall encouraging factor is, the more the public expect for the occurrence of the news.

3. The financial analysis system according to claim 2, wherein during the processor executes the vocabulary analysis to calculate the overall optimistic factor and the overall encouraging factor at every time point within the predetermined time segment according to the news, the processor executes the analysis program for:
calculating an optimistic factor and an encouraging factor for each news;
calculating an average for the optimistic factors of the news to be the overall optimistic factor, and calculating an average for the encouraging factors of the news to be the overall encouraging factor.

4. The financial analysis system according to claim 3, wherein the processor executes the analysis program further for:
determining whether the optimistic factor of the news is larger than or equal to a first predetermined value or is smaller than a second predetermined value, and accordingly calculating a positive article number and a negative article number at every time point within the predetermined time segment as the analysis result;
adding 1 to the positive article number when the optimistic factor of the news is larger than or equal to the first predetermined value; and
adding 1 to the negative article number when the optimistic factor of the news is smaller than the second predetermined value.

5. The financial analysis system according to claim 1, wherein the keyword is a stock symbol, when the processor searches for the news related to the keyword through the server, the processor searches for the news, through the server, in which a company name corresponding to the stock symbol shows.

6. The financial analysis system according to claim 1, wherein the keyword is a company name, when the processor searches for the news related to the keyword through the server, the processor searches for the news, through the server, in which the company name shows.

7. The financial analysis system according to claim 5, wherein the processor executes the analysis program further for:
counting how many times the company name shows in the news found, and accordingly calculating an exposure factor as the analysis result.

8. The financial analysis system according to claim 6, wherein the processor executes the analysis program further for:
counting how many times the company name shows in the news found, and accordingly calculating an exposure factor as the analysis result.

9. The financial analysis system according to claim 1, wherein the user interface is further configured to input a specific time segment, and the processor searches for the news related to the keyword within the specific time segment in the database.

10. The financial analysis system according to claim 1, wherein after the processor searches for the news related to the keyword within the predetermined time segment through the server, the processor executes the analysis program further for:
calculating and generating a word cloud as the analysis result according to the news.

11. The financial analysis system according to claim 1, wherein after the processor searches for the news related to the keyword within the predetermined time segment through the server, the processor executes the analysis program further for:
capturing some of the news related to the keyword through the server according to a selected time segment; and
calculating and generating a word cloud as the analysis result according to the captured news.

12. A financial analysis method for unstructured text data, adapted to a financial analysis system for unstructured text data, wherein the financial analysis system for unstructured text data includes a user interface, a server, memory and a processor, the user interface is configured to input a keyword and display an analysis result, the server is configured to operate a database, the memory is configured to store an analysis program, the processor is connected to the user interface, the server and the memory, and the processor is configured to execute the analysis program to implement the financial analysis method for unstructured text data, comprising:
searching for a plurality of news related to the keyword within a predetermined time segment through the server;
executing a vocabulary analysis at every time point within the predetermined time segment according to the news to calculate an overall optimistic factor and an overall encouraging factor as the analysis result;
wherein the overall optimistic factor is defined as what the emotion the public may have when hearing the news, and the overall encouraging factor is defined as how the public expect for the occurrence of the news.

13. The financial analysis method according to claim 12, wherein the overall optimistic factor is a real number from 1 to 9, and the larger the overall optimistic factor is, the more optimistic the public may be when hearing the news, and the smaller the overall optimistic factor is, the more pessimistic the public may be when hearing the news, and wherein the overall encouraging factor is a real number from 1 to 9, and the larger the overall encouraging factor is, the more the public expect for the occurrence of the news.

14. The financial analysis method according to claim 13, wherein the step of executing the vocabulary analysis to calculate the overall optimistic factor and the overall encouraging factor according to the news further includes:
calculating an optimistic factor and an encouraging factor for each news;
calculating an average for the optimistic factors of the news to be the overall optimistic factor, and calculating an average for the encouraging factors of the news to be the overall encouraging factor.

15. The financial analysis method according to claim 14, further comprising:
determining whether the optimistic factor of the news is larger than or equal to a first predetermined value or is smaller than a second predetermined value, and accordingly calculating a positive article number and a negative article number at every time point within the predetermined time segment as the analysis result;
adding 1 to the positive article number when the optimistic factor of the news is larger than or equal to the first predetermined value; and
adding 1 to the negative article number when the optimistic factor of the news is smaller than the second predetermined value.

16. The financial analysis method according to claim 12, wherein the keyword is a stock symbol, when the processor searches for the news related to the keyword through the server, the processor searches for the news, through the server, in which a company name corresponding to the stock symbol shows.

17. The financial analysis method according to claim 12, wherein the keyword is a company name, when the processor searches for the news related to the keyword through the server, the processor searches for the news, through the server, in which the company name shows.

18. The financial analysis method according to claim 16, further comprising:
counting how many times the company name shows in the news found, and accordingly calculating an exposure factor as the analysis result.

19. The financial analysis method according to claim 17, further comprising:
counting how many times the company name shows in the news found, and accordingly calculating an exposure factor as the analysis result.

20. The financial analysis method according to claim 12, wherein the user interface is further configured to input a specific time segment, and the processor searches for the news related to the keyword within the specific time segment in the database.

21. The financial analysis method according to claim 12, wherein after the step of searching for the news related to the keyword within the predetermined time segment through the server, the financial analysis method further comprises:
calculating and generating a word cloud as the analysis result according to the news.

22. The financial analysis method according to claim 12, wherein after the step of searching for the news related to the keyword within the predetermined time segment through the server, the financial analysis method further comprises:
capturing some of the news related to the keyword through the server according to a selected time segment; and
calculating and generating a word cloud as the analysis result according to the captured news.
